(19) United States
(12) Patent Application Publication
(10) Pub. No.: US 2003/0059586 A1
(43) Pub. Date: Mar. 27, 2003

(54) Identifying label for photographic article and method

(76) Inventors: Andrea Johnson, Southfield, MI (US); Brooke Johnson, Southfield, MI (US)

Correspondence Address: Douglas A. Mullen, Dickinson Wright PLLC, Suite 800, 1901 L. Street NW, Washington, DC, 20036, US

(21) Appl. No.: 10/253,707

(22) Filed: Sep. 25, 2002

Related U.S. Application Data
(60) Provisional application No. 60/325,088, filed on Sep. 26, 2001.

(51) Int. Cl. B32B 3/00

(52) U.S. Cl. 428/195

(57) ABSTRACT

An identification label for use with a photographic article and a method for use of the label. The photographic article has an exterior surface and an identification label coupled to the exterior surface. The identification label includes a writable surface for recording the content of the film in the article. The method of using the identification label includes recording identification information on the label and coupling the label to the article.

### CROSS-REFERENCE TO RELATED APPLICATION

This application claims the benefit of U.S. Provisional Application No. 60/325,088, filed Sep. 26, 2001, the entire disclosure of this application being considered part of the disclosure of this application and hereby incorporated by reference.

### BACKGROUND AND SUMMARY OF THE INVENTION

The present invention is generally directed to an identification label for use on photographic articles, photographic articles containing the identification label, and a method of using the identification label to identify the contents of photographic film.

There is often times a delay between the time that an individual takes pictures of an event and the time that the film is developed. During this delay several rolls of film may accumulate and the photographer may forget the subject of the photographs on a particular roll of film, the date the photographs were taken, and/or the event depicted in the photos. The present invention is directed to an apparatus and method for labeling photographic articles, such as disposable cameras, film canisters, film rolls themselves, and the like, to permit the consumer to keep track of the contents of the film prior to development.

Further scope of applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

The present invention will become more fully understood from the detailed description given here below, the appended claims, and the accompanying drawings in which:

FIG. 1 illustrates an identification label according to the present invention;

FIG. 2 illustrates a writing instrument for use with the label;

FIG. 3 illustrates the label with written identification information pertaining to the contents of the photographic article;

FIG. 4 illustrates a sheet containing a plurality of identification labels;

FIG. 5 is a top plan view showing the cover of a film canister having an identification label;

FIG. 6 illustrates a camera having an identification label; and

FIG. 7 illustrates a film roll having an identification label.

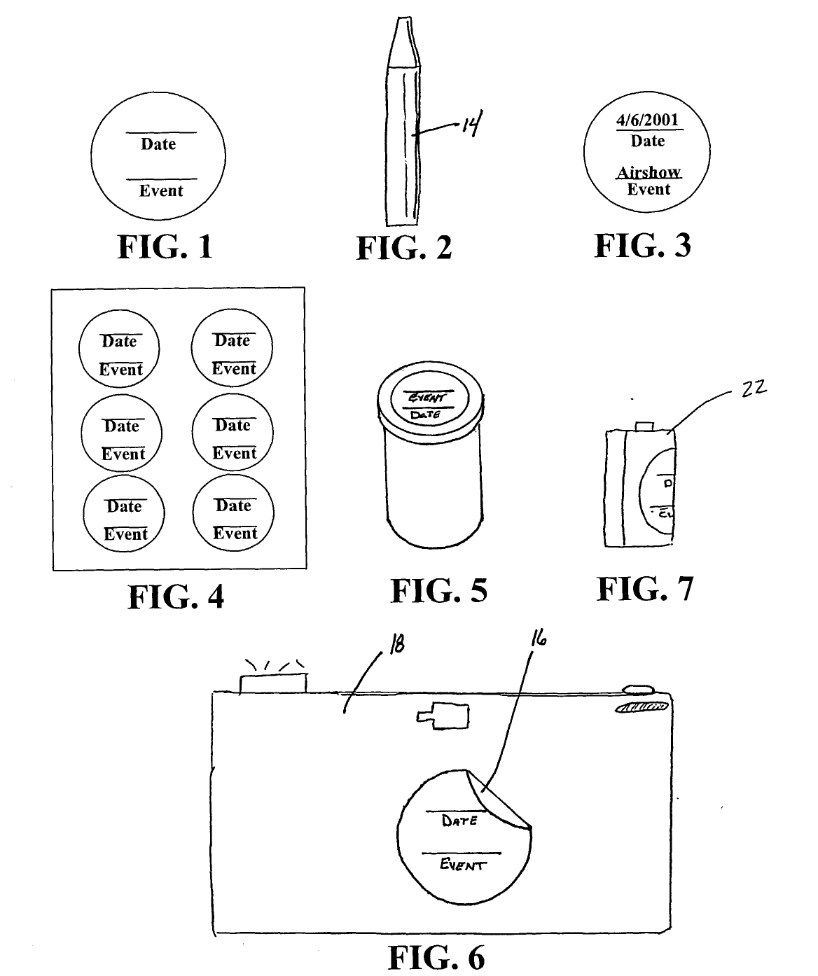

### DETAILED DESCRIPTION OF THE PREFERRED EMBODIMENT

As is illustrated in the attached figures, an embodiment of the present invention includes an identification label 10 having a writable surface 12 for recording identification information. The information may be written on the surface 12 via conventional means, including typing or through a writing utensil such as the illustrated non-smearing pen 14 (FIG. 2). Exemplary labels may come in multi-label sheets such as is illustrated in FIG. 4 and manufactured by Label Blank Corporation. While the labels may be of many sizes and shapes, one and one-quarter inch diameter round labels are preferred as they are appropriately sized for a 35 mm film canister and suitable for placement on a one-time use camera as well as 35 mm and 120 mm film rolls. The labels also preferably include defined fields for recording information such as the date and the event fields depicted in the illustrated labels. It should be appreciated that the information recorded on the writable surface may be varied to include other and/or additional identification information without departing from the scope of the invention. Finally, for attractiveness and ease of identification, it is preferred that the writable surface 12 of the label 10 have a visually appealing color, such as orange or other neon colors.

The label 10 also includes a coupling surface 16 opposite the writable surface 12 as shown by the bent label in FIG. 6. The coupling surface preferably includes an adhesive that permits secure attachment of the label to an exterior surface of the photographic article (e.g., the camera housing, or external surfaces of the canister or film roll). The adhesive also preferably permits removal of the individual labels from the sheet shown in FIG. 4 as well as selective removal from the labeled photographic articles when desired.

As generally indicated above, the identification label may be affixed to a variety of photographic articles for ease of tracking the contents of the film. Examples include the disposable camera 18 shown in FIG. 6, the film canister 20 shown in FIG. 5, and the roll of film 22 illustrated in FIG. 7.

The present invention is also directed to a method of using the identification label to identify the contents of photographic film. The method generally includes the steps of recording identification information on the label, and attaching the label to a photographic article which may include, but is not limited to, any of the aforementioned disposable camera 18, canister 20, and film roll 22. Additionally representative steps and methods covered by the present invention include attaching the label to a non-disposable camera, loading film into the camera, taking pictures, removing the film from the camera, and transferring the identification label from the non-disposable camera to the film roll 22 or canister 20.

Based on the foregoing description, it should be appreciated that the invention eliminates the guess work of determining the content of pictures included in a roll of film or disposable camera, especially for those who do not develop their film promptly. The invention enables consumers to identify the nature of the pictures and prioritize the development of their photographs.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

What is claimed is:

1. A photographic article containing film, said photographic article comprising:
an exterior surface; and
an identification label removably coupled to the exterior surface, said identification label having a writable surface for recording information regarding the content of the film in the article.

2. The photographic article of claim 1 wherein the article is a camera.

3. The photographic article of claim 1 wherein the article is a film canister.

4. The photographic article of claim 1 wherein the article is a roll of film.

5. The photographic article of claim 1 wherein the identification label includes an adhesive opposite the writable surface.

6. The photographic article of claim 1 wherein the identification label includes a date field.

7. The photographic article of claim 1 wherein the identification label includes an event field.

8. A method of using an identification label to identify the contents of photographic film comprising:
recording identification information on a writable surface of a label; and
coupling the label to a photographic article that contains the photographic film.

9. The method of claim 8 wherein the photographic article to which the label is coupled is a camera.

10. The method of claim 9 wherein the step of recording identification information is performed after the step of coupling the label to the camera.

11. The method of claim 10 further including the step of transferring the label from the camera to a second photographic article containing the film.

12. The method of claim 11 wherein said second photographic article is a film canister.
